(19) United States
(12) Patent Application Publication
(10) Pub. No.: US 2004/0190625 A1
(43) Pub. Date: Sep. 30, 2004

(54) Programmable video encoding accelerator method and apparatus

(75) Inventors: Zhongli He, Schaumburg, IL (US); Chandrasekhar Lakshmanan, Schaumburg, IL (US); Kathy Moseler, Barrington, IL (US); Gopala Krishnan Srinivasan, Singapore (SG); Raghavan Subramaniyan, Schaumburg, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/388,125

(22) Filed: Mar. 13, 2003

(51) Int. Cl. H04N 11/04; H04N 11/02; H04N 7/12; H04B 1/66

(52) U.S. Cl. 375/240.18; 375/240.2

(57) ABSTRACT

A programmable video encoding accelerator having a substantially hardware-based transform coder that has at least a first video input and a second video input. In a preferred embodiment, the first video input is operably coupleable to an integral native difference computer and the second video input is operably coupleable to an external video feed that does not pass through the native difference computer.

### RELATED APPLICATIONS

Programmable Video Motion Accelerator Method and Apparatus (attorney's docket number CML04082N/78584) as filed on even date herewith, and Information Storage and Retrieval Method and Apparatus (attorney's docket number CML00991N/78583) as also filed on even date herewith, wherein both such related applications are incorporated herein by this reference.

### TECHNICAL FIELD

This invention relates generally to video image processing and more particularly to digital video encoding acceleration.

### BACKGROUND

Video processing (including both video motion and still imagery processing) comprises a relatively well known and understood art and includes both video compression and decompression techniques. To meet particuarly emphasized design requirements, various platforms intended to support such processing have been proposed with substantially total hardware-based implementations (thereby usually tending to emphasize speed and/or bandwidth performance capabilities and power consumption), substantially total software-based implementations (thereby usually tending to emphasize programmability and flexibility), and mixed hardware/software implementations (usually where the strengths of both are compromised to achieve some limited increase among speed/bandwidth/power consumption in conjunction with some flexibility though usually with a number of associated typically undesirable trade-offs and compromises as well).

Generally speaking, such prior art platforms tend to implement only one or a very few video processing algorithms (with this being generally evident even with software-based platforms, often because the algorithms being implemented in this way are themselves carefully constructed and utilized to attempt to minimize the usual reduction in speed/bandwidth that one associates with such an embodiment).

As a simple illustration, some video processing platforms support only one approach to achieve video encoding. Suggestions to support greater flexibility in this regard tend to rely upon architectures that are often suitable for some implementations but that tend to be less desirable for integrated solutions where the embodiment preferably comprises a minimal number of integrated circuits.

Such issues become particularly acute when seeking to support video processing capabilities in a small device that relies upon a small portable power supply, and especially so when significant cost restrictions further limit the design freedom of the device architect. For example, a wireless two-way communications device, such as a cellphone, will often be constrained by significant cost and power-efficiency requirements as well as critical form-factor and size limitations. Such issues tend to limit the feasibility of software-based solutions (for example, the power needs required to operate a video processing software platform will often well surpass the performance efficiency targets for such a device) as well as the feasibility of hardware-based solutions (one particular problem is the desire of the manufacturer to offer a basic platform that will function compatibly in a variety of systems, as this need collides with the reality that many different systems in which such a device might be otherwise used tend to require the availability of a number of different incompatible video processing algorithms and techniques). In general, faced with this and other similar quandaries, manufacturers tend to favor hardware-based solutions (to obtain the speed and power consumption benefits) that are unique to corresponding unique market segments and to forgo the economies of scale that one can achieve with a more flexible approach (in order to avoid the speed and power consumption problems associated with such approaches).

### BRIEF DESCRIPTION OF THE DRAWINGS

The above needs are at least partially met through provision of the programmable video encoding accelerator method and apparatus described in the following detailed description, particularly when studied in conjunction with the drawings, wherein:

FIG. 1 comprises a generalized block diagram as configured in accordance with an embodiment of the invention;

FIG. 2 comprises a more detailed block diagram as configured in accordance with an embodiment of the invention;

FIG. 3 comprises a more detailed block diagram as configured in accordance with an embodiment of the invention;

FIG. 4 comprises a generalized block diagram as configured in accordance with an embodiment of the invention; and

FIG. 5 comprises a more detailed block diagram as configured in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, an integrated programmable video encoding accelerator can be comprised of a hardware-based transform coder having at least a first video input and a second video input. In a preferred embodiment, the first video input is operably coupleable to an integral native difference computer and the second video input is operably coupleable to an external video feed that does not pass through the native difference computer.

In a preferred approach, the transform coder includes both a programmably selectable discrete cosine transform coder and a programmably selectable inverse discrete cosine transform coder. Pursuant to another preferred approach, the transform coder is also operably coupled to a host processor interface. In yet another preferred approach, the programmable video encoding accelerator further includes native motion estimation and/or motion compensation capability.

With these various embodiments, one can provide a device that will support a variety of video processing techniques and algorithms, including even approaches that differ with respect to the need for (and/or the kind of) transform coding, motion estimation, and/or motion compensation. Further, if desired, these embodiments will support compatible supportive interaction with other non-integral video processing elements, including a video processing host and/or one or more other video accelerators.

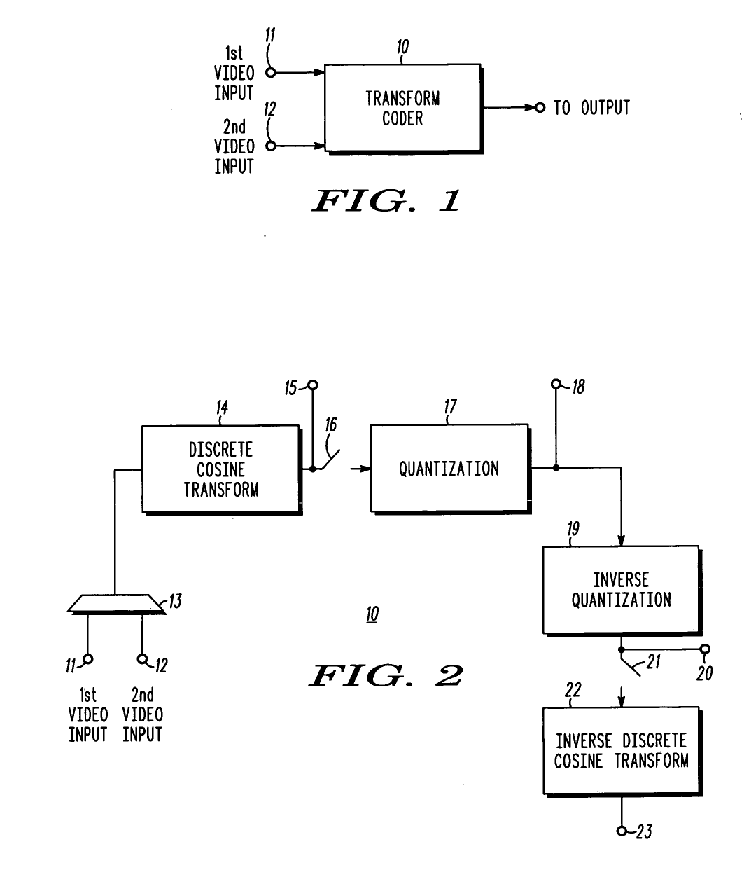

Referring now to the drawings, and in particular to FIG. 1, a programmable video encoding accelerator can include a substantially hardware-based transform coder 10. In a preferred approach, the transform coder 10 includes at least a first video input 11 and a second video input 12. As will be shown below, such alternative input capabilities permits video information from different selectable sources to be chosen for processing by the transform coder 10. As will also be shown below, these selectable sources can include at least a native difference computer (as comprises a part of a motion compensator) and a video feed that does not pass through such a motion compensator. Such an approach affords a considerable degree of programmable latitude with respect to the range of video processing methodologies that can be compatibly supported by the programmable video encoding accelerator.

Referring now to FIG. 2, a somewhat more detailed view of a preferred transform coder 10 will be described. Viewed schematically, the two video inputs 11 and 12 can be gated and/or multiplexed 13 under the control of, for example, an internal or external host process to permit selection of a particular video source for presentation to a discrete cosine transform unit 14. The output of the latter can couple to both an external access point 15 (to permit external receipt of the discrete cosine transform output and/or to facilitate other internal routing of this output as programmably directed) and via a host process-controlled switch or gate 16 to a quantization unit 17. The quantization output couples to both another external access point 18 and to an inverse quantization unit 19. The output of the latter couples as well to yet another external access point 20 and through another host process-controlled switch or gate 21 to an inverse discrete cosine transform unit 22. The output 23 of the latter is then available for coupling as desired.

In general, the discrete cosine transform unit 14, the quantization unit 17, the inverse quantization unit 19, and the inverse discrete cosine transform unit 22 can be comprised of now known or hereafter developed such modules as desired and/or as appropriate to a given application. It should be appreciated, however, that the described configuration, though highly hardware-based, offers considerable flexibility with respect to signal routing and the usage of any given module in support of a particular video processing algorithm and/or compatible usage with a particular external mechanism (such as a particular software-based host or processor, digital signal processing platform, other accelerators, and so forth). It should also be appreciated that, if desired, many of the described external output points can also serve as an input point to further facilitate such flexible compatibility (to illustrate, already transformed-and-quantized data can be introduced to the inverse quantization unit 19 via the external access point 18 where it may also be appropriate to open the switch/gate 16 at the input side of the quantization unit 17).

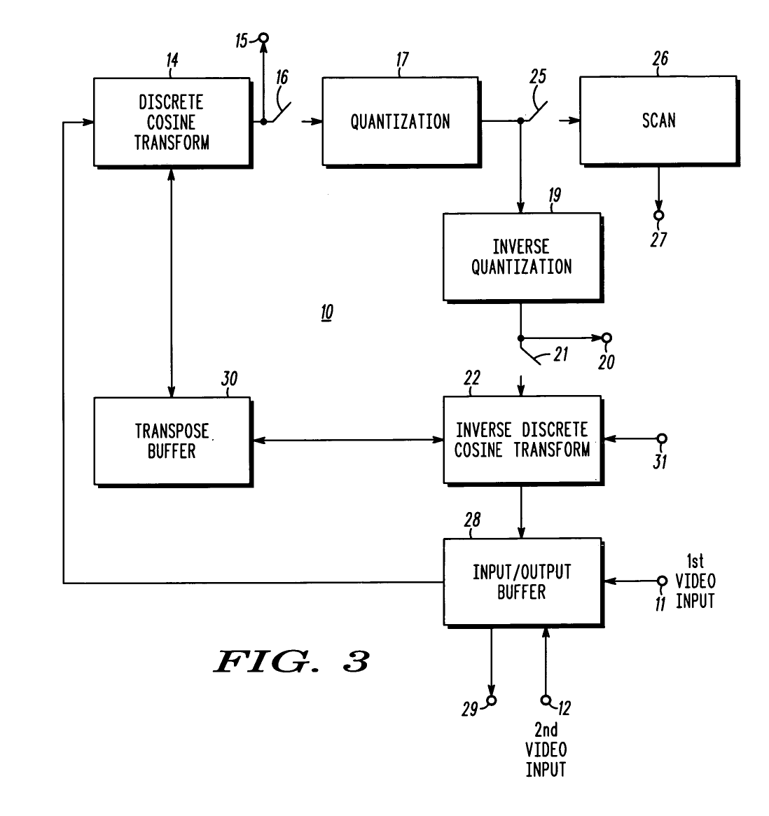

FIG. 3 presents an exemplary embodiment of a transform coder 10 that accords with the above architectural teachings. In this embodiment, the transform coder 10 includes a native scan and inverse scan (e.g. zig-zag) capability 26 that selectively couples to the output of the quantization unit 17 via a host process-controlled switch or gate 25, with the resultant output 27 being available for internal or external routing as desired or appropriate to a given application. Also in this embodiment, buffers are used to facilitate the exchange and/or availability of data to be processed and/or processed data. For example, an input/output buffer 28 (having, for example, a 32×32 bit size) can serve a plurality of purposes. In this embodiment, this buffer 28 can receive data from the inverse discrete cosine transform unit 22 or from either of the at least two video inputs 11 and 12. This same buffer 28 can also provide output to the discrete cosine transform unit 14 and/or to an external output point 29 to permit data routing elsewhere within or external to the video encoding accelerator. Another buffer comprises a transpose buffer 30 and couples to both the discrete cosine transform unit 14 and the inverse discrete cosine transform unit 22. This embodiment also demonstrates that other externally sourced couplings are permitted as well. For example, the inverse discrete cosine transform unit 22 includes an input that couples to such an external access point 31.

So configured, the transform coder 10 can be seen to comprise a substantially hardware-based transform coder having a plurality of modules that are selectively inter-coupled and/or externally coupled to effect a wide variety of useful configurations that will readily accommodate a number of different algorithmic and/or architectural possibilities.

A video accelerator can benefit from functionality that supplements the transform coding provided by the transform coder 10. For example, motion estimation and motion compensation are both processing activities that find potential application in such a context. When incorporating such features into a video accelerator that includes the above described transform coder 10, in a preferred embodiment these modules are also provided with a degree of programmability.

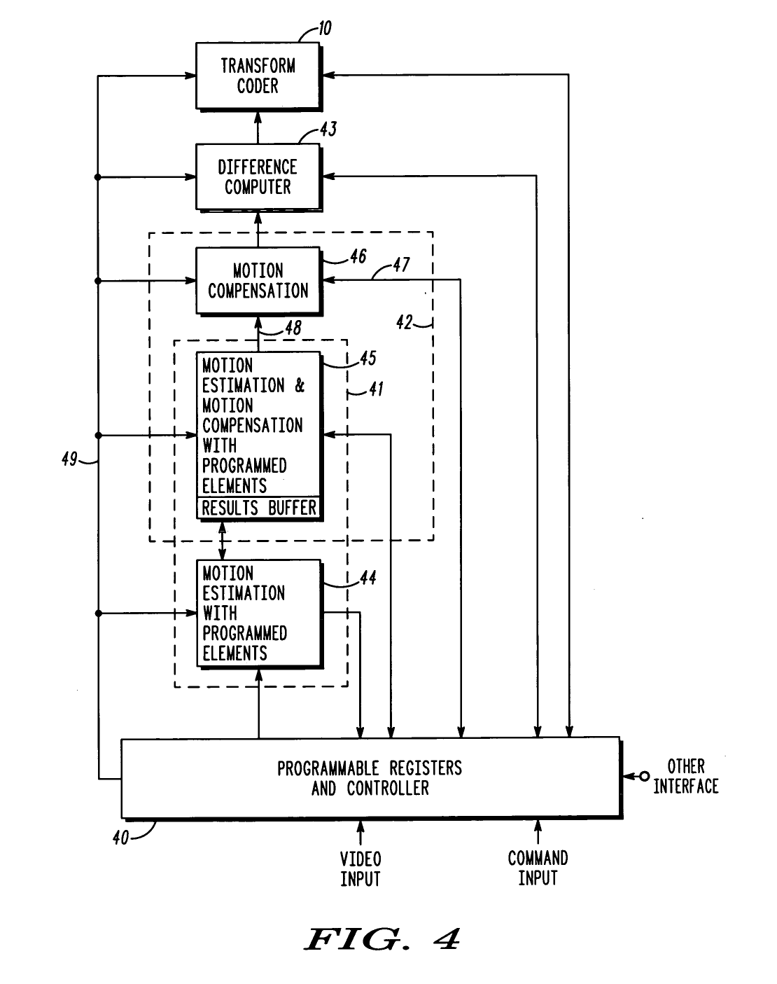

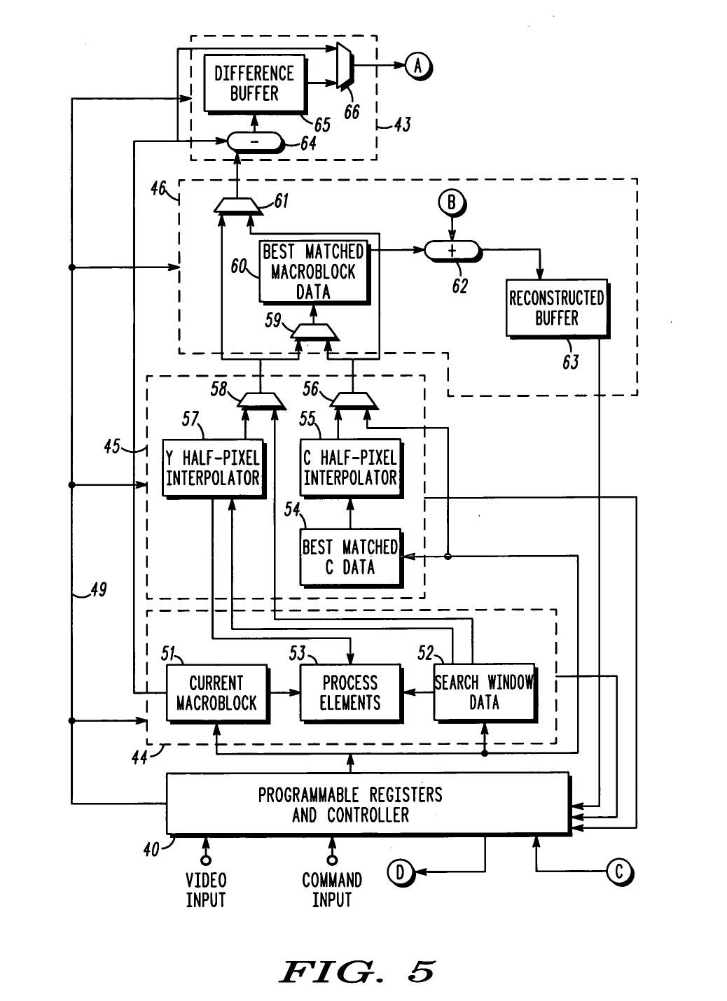

Referring now to FIG. 4, an accelerator can have programmable registers and a controller 40 that comprise a fully feature-programmable datapath/memory controller foundation that serves, as shown below, to interface with other outboard units and to also permit programmed selective element configuration and intercoupling of other components of the accelerator including the transform coder 10. In this regard, the controller 40 comprises a datapath controller that is integral to such other components. Towards such ends, the controller 40 has at least one video data input (to permit introduction of video information to be processed by the accelerator) and further has one or more command inputs to facilitate interfacing and interacting with at least one other external processor (not shown) such as, for example, a host controller. Other interfaces can also be provided as desired, including, for example, an interface to permit coupling of this accelerator to one or more other accelerators (to permit, for example, serial processing of a different type and/or parallel processing).

In a preferred embodiment, this controller 40 includes all the programmable registers that are visible to a host to facilitate command writes. So configured, upon receipt of commands from such a host, the controller 40 will configure the other components and/or modules of the accelerator to perform and/or otherwise facilitate the required operations. In a preferred embodiment, the controller 40 also includes a picture extension padder as well understood in the art (wherein the picture extension padder serves to replicate the nearest edge pixels when a given motion vector points outside the present frame), though, if desired, a picture extension padder can be provided external to the accelerator (such as native to a given host that interfaces to the accelerator).

Generally speaking, in this embodiment, the accelerator also integrally includes the previously mentioned transform coder 10, a motion estimator 41, a motion compensator 42, and a difference computer 43. In a preferred embodiment, all of these modules are at least substantially hardware-based. So configured, of course, these modules are fast and relatively power-consumption efficient. At the same time, as will be seen below, two of these modules in addition to the transform coder 10 are largely comprised of programmable elements (in response to configuration control signaling from the controller 40) and all of them can be selectively intercoupled as well (again in response to the controller 40).

The motion estimator 41 is comprised of a first part that comprises motion estimation with programmed elements 44. This portion of the motion estimator 41 comprises hardware-based motion estimation-elements that are at least to some extent reconfigurable under the control of the controller 40. Another portion of the motion estimator 41 is shared with the motion compensator 42 and comprises hardware-based motion estimation and motion compensation elements 45 that are, again, programmable in response to the controller 40. In a preferred embodiment, these shared elements include at least one or more results buffer. For example, a chrominance results buffer and a luminance results buffer can both be provided in this way. So configured, required circuitry can be reduced while further reducing power consumption needs as these elements 45 are shared by both the motion estimator 41 and the motion compensator 42 (regardless of whether, in a given programmed configuration, both the estimator 41 and the compensator 42 are being used and applied).

The motion compensator 42 is similarly comprised of both the shared programmable elements 45 noted above and additional motion compensation elements 46. The latter elements 46, in a preferred embodiment, need not be programmable as such, but the controller 40 still retains a degree of selective configurability with respect thereto. In a preferred embodiment, this motion compensation module 46 has a first video input 47 (to permit receipt of video data directly from, for example, the controller 40) as well as at least a second video input 48 that is integral to and operably selectively coupled to the video motion estimator 41. So configured, the motion compensator 42 can process video data for motion compensation as sourced by either the motion estimator 45 or the controller 40, thereby permitting considerable programmable flexibility with respect to inclusion or exclusion of the motion estimator 41.

To permit and facilitate such programmable element selection and module configuration, the controller 40 couples via appropriate control lines 49 to each such module. In a similar fashion, raw or processed data is passed from or to the controller 40 and these various modules via corresponding data lines.

Referring now to FIG. 4, a more detailed description of such a motion estimator, motion compensator, and difference computer will be presented. Here, it can be seen that, in a preferred embodiment, the programmable elements 44 of the motion estimator include a current macroblock unit 51 (such as a 2 bank buffer having a 6×8×8×8 bit size and serving to store current macroblock data for both the luminance and chrominance information), a search window data unit 52 (such as a 48×48×8 bit buffer) (both as selectively fed by the controller 40) and one or more desired and appropriate motion estimation process elements 53 such as but not limited to absolute difference elements, accumulators, mode calculators, and so forth (with inputs as selectively coupled from the current macroblock unit 51, the search window data 52, and the luminance interpolator portion of the shared programmable elements 45 as related in more detail below). Such constituent elements of a motion estimator are generally well understood in the art and hence additional description will not be provided here for the sake of brevity and the preservation of focus. In general, these parts of the motion estimator 41 are an integral part of the motion estimator and are not used as part of another function or feature. The configuration described, however, will permit considerable flexibility with respect to selection and programmed configuration of such elements via the control line(s) 49 and the controller 40.

The shared programmable elements 45 as generally noted above include, in a preferred embodiment, elements that pertain to both chrominance and luminance information. For chrominance information, a best matched chrominance data buffer 54 (having, for example, a 2×9×9×8 bit size) can selectively receive corresponding video data from the controller 40 and then provide that information to a chrominance half-pixel interpolator 55 as is otherwise well understood in the art. A chrominance data multiplexer 56 then receives the interpolator 55 output and/or the chrominance information as is otherwise provided by the controller 40 as will vary with the programmed behavior of these elements such that the controller selected input is then available to the motion compensator 46 as described below. For luminance information, a luminance half-pixel interpolator 57 as is otherwise well understood in the art receives input from the search window data buffer 52 of the motion estimator and provides a corresponding output to both the process elements 53 of the motion estimator and a luminance data multiplexer 58. The latter also receives luminance data input from the search window data buffer 52 and provides the selected input (as directed by the controller 40) to the motion compensator 46, again as described below in more detail.

So configured, these elements 45 serve the purposes of both the motion estimator 41 and the motion compensator 42. The resultant reduced parts count aids in reducing the required size and power requirements of the resultant device and the selectable configuration permits these elements to support a wide variety of algorithms and other video processing techniques.

The motion compensation elements 46 include, in this embodiment, an input multiplexer 59 (which receives an input from both the luminance and the chrominance output multiplexers 58 and 56 noted above) that feeds a best matched macroblock data buffer 60 (having, for example, a 6×8×8×8 bit size). Another multiplexer 61 also receives the outputs of the luminance and chrominance output multiplexers 58 and 56 and serves to selectively provide such data to the difference computer 43 when so configured by the controller 40. The output of the best matched macroblock data buffer 60 of the motion compensator couples to an adder 62 that has another input that can be operably coupled, for example, to a corresponding data output of the controller 40 (this configuration can be used, for example, to input the results of the transform coder 10 via the controller 40 to the motion compensator adder 62) or to an output of the transform coder 10 (such as an output 29 of the transform coder input/output buffer 28). The motion compensated results as output by the adder 62 are provided to a reconstructed buffer 63 (having, for example, a 6×8×8×8 bit size) which then couples to a data input of the controller 40.

So configured, the motion compensator can be configured as desired to facilitate motion compensation with various data sources and as a function of compensation information that is itself based upon selectably variable data sources. Again, control signaling from the controller 40 via the control line(s) 19 can be used, at a minimum, to control the various described multiplexers to select and steer the various described data inputs and outputs as appropriate to effect a given video processing approach.

The difference computer 43 comprises, in this embodiment, a subtractor 64 operably coupled to the output of the motion compensation multiplexer 61 to receive a first set of luminance and chrominance data and to an output of the current macroblock 51 of the motion estimator 44 to receive a second set of luminance and chrominance data. A difference buffer 65 stores the resultant difference information. An output multiplexer 66 then serves to selectively output to, for example, the controller 40 or the transform coder 10, either the contents of the difference buffer 65 or the luminance and chrominance information as sourced by the current macroblock 51 of the motion estimator.

The above embodiment can be readily realized as a single integrated circuit. As already noted, the transform coder, motion estimation, motion compensation, and difference calculator are all substantially hardware-based and yet are readily reconfigurable in a selectable and programmable fashion via the controller 40 (for example, the various multiplexers can be used, singly or in multiples, to select or de-select various portions of these modules for usage in a given application). It should also be clear that, notwithstanding the inclusion and availability of the above described modules, if desired and as appropriate to a given application one may nevertheless effect one of more of the supported functions or features external to the accelerator. As one pertinent example, an external processor (including but not limited to any of a microprocessor, a digital signal processor, or another accelerator platform) can be used to execute, in tandem with the functioning of the accelerator described above, a motion estimation algorithm notwithstanding the availability of the described native motion estimator 11.

A video encoding accelerator can be conveniently viewed as comprising three primary parts; a video motion accelerator datapath (which includes, for example, the motion estimation and motion compensation modules when present), a DCT pipeline (which includes, in the above embodiments, the discrete cosine transform unit 14, the quantization unit 17, the inverse quantization unit 19, and the inverse discrete cosine transform unit 22), and the accelerator controller 40. Such an accelerator can perform the entire digital pulse code modulation loop in a typical standarized video encoding scheme and can perform around 90% of the computation, leaving only around 10% of the computation load (such as AC/DC prediction, Variable Length Coding (VLC), and rate control) in a corresponding host.

The DCT pipline can perform discrete transform coding transformation on the differential component of the macroblock input from the video motion accelerator datapath. In addition, it can also perform quantization and preferably arrange the output in any one of a vertical, horizontal, or zigzag pattern. If desired, two-dimensional discrete cosine transformation can be facilitated by performing a one-dimension discrete cosine transformation first on the input and then on the transposed one-dimensional discrete cosine transformed data. The transformed and quantized result can be written to the macroblock buffer and thereby made available for further encoding (such as AC/DC prediction, variable length coder (VLC), and so forth).

This data stored in the buffer can also be inverse quantized and inverse discrete cosine transformed to recreate the original data. Interfaces and hand shaking signals can be established between the video motion accelerator datapath and the discrete cosine transformation pipeline datapath to facilitate easy transfer of data between the modules. Polling bits can be used in the interface of the discrete cosine transformation module to the system to indicate internal status and/or activity and hence prevent any other input in the case of the system wanting to use the module in contention with the video motion accelerator datapath.

It should also be clear that, notwithstanding the inclusion and availability of the above described modules, if desired and as appropriate to a given application one may nevertheless effect one of more of the supported functions or features external to the accelerator. As one pertinent example, an external processor (including but not limited to any of a microprocessor, a digital signal processor, or another accelerator platform) can be used to execute, in tandem with the functioning of the accelerator described above, a motion estimation algorithm notwithstanding the availability of the described native motion estimator 41.

The above described embodiments yield a number of useful benefits depending upon the particular features and/or configuration utilized for a given application. These approaches tend to be simple and efficient for handheld device video applications, and the centralized controller simplifies the control flow. Pixel-level parallel operation can be supported while also permitting block-level performance during serial operations. The programmability of these embodiments facilitate useful support of various motion estimation algorithms and in general, these modules can be used with relatively minimal host-accelerator interactions being required. The motion estimation module generally comprises a substantially modular and programmable engine.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A programmable video encoding accelerator comprising a substantially hardware-based transform coder having at least a first video input and a second video input.

2. The programmable video encoding accelerator of claim 1 wherein the first video input is operably coupleable to an integral native difference computer.

3. The programmable video encoding accelerator of claim 2 wherein the second video input is operably coupleable to an external video feed that does not pass through the native difference computer.

4. The programmable video encoding accelerator of claim 1 wherein the transform coder includes both a programmably selectable discrete cosine transform coder and a programmably selectable inverse discrete cosine transform coder.

5. The programmable video encoding accelerator and further including a host processor interface that is operably coupled to the transform coder.

6. The programmable video encoding accelerator of claim 1 wherein the transform coder has a plurality of user selectable quantization step-sizes.

7. The programmable video encoding accelerator of claim 1 wherein the transform coder accepts a plurality of user-defined de-quantization processes.

8. The programmable video encoding accelerator of claim 1 and further comprising a non-integral computing platform that is operably coupleable to the transform coder.

9. The programmable video encoding accelerator of claim 8 wherein the computing platform includes an AC/DC prediction module.

10. The programmable video encoding accelerator of claim 8 wherein the computing platform includes a variable length coding module.

11. The programmable video encoding accelerator of claim 8 wherein the computing platform includes a rate-control module.

12. The programmable video encoding accelerator of claim 1 and further comprising an integral native hardware-based difference computer that is programmably operably coupleable to the transform coder

13. The programmable video encoding accelerator of claim 1 and further comprising an integral native hardware-based video motion compensator that is coupleable to the transform coder.

14. The programmable video encoding accelerator of claim 13 and further comprising an integral native hardware-based video motion estimator that is programmably operably coupleable to the video motion compensator.

15. The programmable video encoding accelerator of claim 14 wherein the video motion estimator includes at least one interpolation circuit.

16. The programmable video encoding accelerator of claim 15 wherein the video motion compensator selectively shares usage of the at least one interpolation circuit.

17. A method comprising:
providing a programmable integrated substantially hardware-based video data transform coder having a plurality of selectable video data inputs;
selecting from amongst the plurality of selectable video data inputs to provide a selected video data input;
providing video data to the transform coder via the selected video data input.

18. The method of claim 17 wherein providing a programmable integrated substantially hardware-based video data transform coder further comprises providing a programmable integrated substantially hardware-based video data transform coder having at least a programmably selectable:
discrete cosine transform coder; and an
inverse discrete cosine transform coder.

19. The method of claim 18 wherein providing a programmable integrated substantially hardware-based video data transform coder having at least a programmably selectable inverse discrete cosine transform coder includes providing a programmable integrated substantially hardware-based video data transform coder having at least a programmably selectable inverse discrete cosine transform coder having a selectable off-board output.

20. The method of claim 18 wherein providing a programmable integrated substantially hardware-based video data transform coder having at least a programmably selectable:
discrete cosine transform coder; and an
inverse discrete cosine transform coder;
further includes providing a memory buffer that is operably coupled to both the discrete cosine transform coder and the inverse discrete cosine transform coder.

21. The method of claim 20 wherein providing a memory buffer includes providing a transpose memory buffer.

22. The method of claim 17 and further comprising providing at least a video data motion compensator that is also integral and native to the video data transform coder.

23. The method of claim 17 and further comprising providing at least a motion difference computer that is also integral and native to the video data transform coder.

24. The method of claim 22 and further comprising providing at least a video data motion estimator that is also integral and native to the video data transform coder.

25. The method of claim 24 wherein providing at least a video data motion compensator and at least a video data motion estimator includes providing a programmable video data motion compensator and a programmable video data motion estimator.

26. The method of claim 25 wherein providing a programmable video data motion compensator and a programmable video data motion estimator includes providing at least one data interpolator that is shared by both the video data motion compensator and the video data motion estimator.

27. The method of claim 26 wherein providing at least one data interpolator includes providing at least two data interpolators that are shared by both the video data motion compensator and the video data motion estimator.

28. The method of claim 27 wherein providing at least two data interpolators includes providing a chrominance data interpolator and a luminance data interpolator.

29. The method of claim 17 and further comprising using at least one external processor to process a motion estimation algorithm.
